(19) United States
(12) Patent Application Publication
(10) Pub. No.: US 2012/0072346 A1
(43) Pub. Date: Mar. 22, 2012

(54) SYSTEM AND METHOD FOR SECURING AND AUTHENTICATING PURCHASE TRANSACTIONS

(75) Inventors: Mirit BARKAN DAYNOVSKY, Tel Aviv (IL); Yona Claire Dureau, Lyon Cedex (FR); Semion Daynovsky, Tel Aviv (IL)

(73) Assignee: YOMIR SP, Tel Aviv (IL)

(21) Appl. No.: 12/883,210

(22) Filed: Sep. 16, 2010

(51) Int. Cl. G06Q 20/00; G06Q 30/00

(52) U.S. Cl. 705/44

(57) ABSTRACT

A system and method for securely authenticating a dual number payment card used in a purchase order is provided. A request to approve the purchase order is received from a cardholder that owns the dual number payment card, via a first path. The request includes a site address of a website, an order number and a second card number of the dual number payment card. A first card number of the dual number payment card, associated with the order number, is received from the website, via a second path. A matching pair of numbers that identifies a stored dual number payment card, is searched in a card details storage. If a first number of the matching pair matches the first card number and a second number of the matching pair matches the second card number; the purchase order is approved.

### FIELD OF THE INVENTION

The present invention relates to security of purchase transactions and more particularly, to a system and a method for securing and authenticating payment card's details that are utilized in an electronic transaction.

### BACKGROUND OF THE INVENTION

Online shopping has become increasingly popular in the recent years with many shoppers preferring the ease and convenience of ordering goods and services online. In spite of this increasing popularity, credit/debit card fraud is the biggest fear that deters many potential shoppers from online shopping.

Although credit card issuers have taken steps to increase the security of online transactions, online payment remains a major area of Internet immaturity. Payment and data transfer security still remain allied problems.

Websites use encryption technology to transfer information from the buyer computer to the online merchant's computer. Encryption scrambles the information that the buyer sends so as to ensure the privacy of data involved in the transaction. Secure websites are identified with a lock icon in the web address bar, a logo from an Internet security provider or an “HTTPS” as part of the URL, but still a vast number of potential buyers are not familiar with these symbols.

Even though the confidential information of the buyer, particularly the credit card number, is encrypted, using a symmetric or asymmetric key mechanism, this vulnerable information is still a target for interception by computer hackers and thieves. There is no guarantee that the hacker will not be able to decrypt the intercepted card details. No server is one hundred percent protected against hacking and no encryption algorithm is one hundred percent decryption proof.

Even if the credit card number is carried in an encrypted form during its journey through the Internet, there is no guarantee that it will still be safe when it arrives at the merchant's site, where it may be stored in a less secure server and may be a target of malicious intentions.

There is a need to provide a system and a method for eliminating the probability of intercepting payment card numbers, for avoiding disclosure of the full details of a payment card and authenticating payment cards without risking their confidential details.

### SUMMARY OF THE INVENTION

According to the present invention there is provided a method for securely authenticating a dual number payment card and approving a purchase order, the method includes the steps of: (i) receiving, from a cardholder, via a first path, a request to approve a purchase order, wherein the request includes a site address of a website, an order number and a second card number of a dual number payment card; (ii) receiving, from the website, via a second network, a first card number of the dual number payment card, associated with the order number; (iii) searching in a card details storage, for a matching pair of numbers that identifies a stored dual number payment card, wherein a first number of the matching pair is equal to the first card number and a second number of the matching pair is equal to the second card number; and (iv) approving the purchase order based on an existence of the matching pair of numbers.

The cardholder sends, to the website, the first card number, via the second path, during a transaction. Then, the website sends the order number to the cardholder.

The cardholder then sends to a validation center, a request to approve the purchase order, via the first path. The request includes the site address of the website, the order number and the second card number of the dual number payment card.

The validation center requests the first card number, associated with the order number, from the website. A matching pair of numbers that identifies a stored dual number payment card is searched in a card details storage. If a first number of the matching pair matches the first card number and a second number of the matching pair matches the second card number; the purchase order is approved. Preferably, an approval notification is sent to the cardholder and to the website.

The validation center may approve the purchase order based on the payment amount and a balance of a financial account associated with the dual number payment card. The validation center may further approve the purchase order based on an expiration date that was predefined for the card and/or based on a restricted number of transactions that was predefined for the card.

A rejection of the purchase order may occur in case the search fails to find the matching pair of numbers.

The validation center may employ a secure vault entity for executing the searching.

Preferably, the first path includes a telephone network and the second path includes the Internet.

According to the present invention there is provided a validation system for secure authentication of a dual number payment card and for a purchase order approval, the system include: (i) a first network interface, for receiving, from a cardholder, via a first network, a request to approve a purchase order, wherein the request includes a site address of a website, an order number and a second card number of a dual number payment card; (ii) a second network interface, for receiving, from the website, via a second network, a first card number of the dual number payment card, associated with the order number; (iii) a card details storage for storing multiple pairs of numbers, corresponding to multiple dual number payment cards; and (iv) a central processor, coupled to the first network interface, to the second network interface and to the card details storage, wherein the central processor is configure to utilize the card details storage, for determining an existence of a matching pair of numbers, that identifies a stored dual number payment card, wherein a first number of the matching pair is equal to the first card number and a second number of the matching pair is equal to the second card number.

The central processor may approve the purchase order based on the existence of the matching pair of numbers.

The communication of the validation center with the website is through the second network interface.

Optionally, the validation system includes a secure vault entity that encloses the card details storage. The secure vault entity includes a vault processor that receives the first card number and the second card number from the central processor, through a secure channel, searches the card details storage for the matching pair, and sends a search result that indicates the existence of the matching pair to the central processor.

Preferably, the first network interface is a telephone network interface and the second network interface is a web network interface.

The first network interface may include at least one of the following devices: (i) electronic text messages gateway that can receive text messages from cardholders and interprets the received text messages, as to extract order details that include: the second card number, the order number and the site address; (ii) a first voice response system that receives dual tone multi frequency (DTMF) signals and parses the DTMF signals into a digital format of the order details; (iii) a second voice response system that records audio messages, and executes a voice recognition algorithm for parsing the recorded audio messages into a digital format of the order details.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a validation system and a dual number payment card, according to an embodiment of the invention;

FIG. 2 illustrates a concept of a virtual triangular path for a branched transfer of split information of the dual number payment card, according to an embodiment of the invention;

FIG. 3A is a sequence diagram illustrating messages flow within a transaction, according to an embodiment of the invention;

FIG. 3B is a sequence diagram that illustrates an example of transaction messages flow, according to an embodiment of the invention;

FIG. 4 is a flowchart of a method for securely authenticating a dual number payment card and approving a purchase order, according to an embodiment of the invention; and

FIG. 5 is a flowchart of a method for providing a dual number payment card.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention is of a system and a method for securing financial transactions of purchases over a network, such as e-commerce transactions. The securing endeavor of the invention concentrates on the most vulnerable part and phase of the transaction, i.e., the confidential card details, particularly while being transmitted over the network. The aim of the system and method presented is to eliminate the probability of malicious interception of the card details circulated on the Internet, regardless of an encryption scheme that may or may not be used to protect vulnerable card details.

Typically, there are two phases of the financial transaction during which the payment card's details can be intercepted: (i) while being transmitted from a purchaser to a commercial website that offers goods or services; and (ii) while being transmitted to a validation center of the card issuer, to authenticate the card details. It should be noted that the remote authentication process itself puts the card details at risk, since this process requires transmission of the card details over the network, from the cardholder or from the merchant to the validation center. Both phases are protected against full card details interception, according to the system and method presented.

The securing concept, offered by the system and method of the invention, is the branching of the transmission of the card details, i.e., separation of identifying details of the card into two parts and never allowing both parts to be transmitted over the same network path.

A purchaser is provided with a payment card, such as a credit card, a debit card, an ATM card, a prepaid card or any other payment card that can be used for e-purchasing over the network. The payment card of the present invention is a dual number payment card that includes two numbers that are required for complete identification and authentication of the card. Only the cardholder and the card issuer have access to both numbers of the card. Any third party, such as a merchant who sells goods or services to the cardholder, is aware of only one number of the dual number payment card.

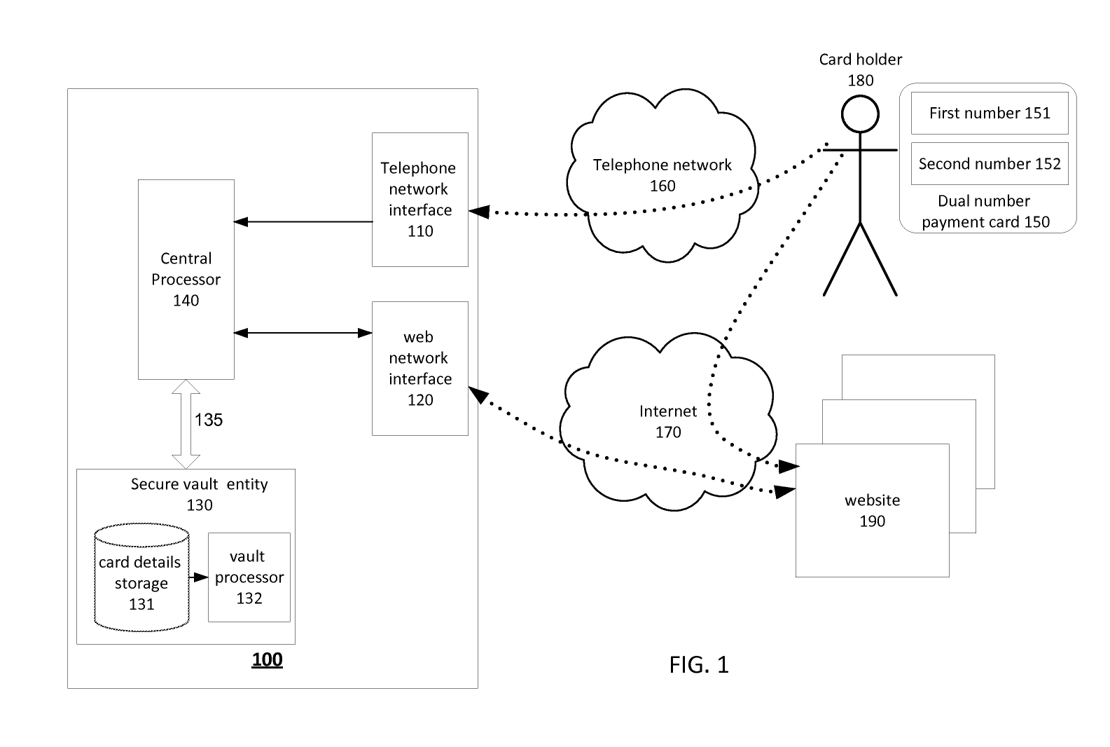

FIG. 1 is a block diagram of a validation system 100 for secure card authentication and for purchase order approval and its connections with cardholders and merchants, e.g., commercial websites. Validation system 100 may reside in a central site of a financial institution that issues dual number payment cards, such as a bank, card issuer and the like.

FIG. 1 also illustrates a dual number payment card 150. A cardholder 180 is provided with the dual number payment card 150 that includes a first card number 151 and a second card number 152. First card number 151 may be considered a card number and second card number 152 may be considered an authentication number, a password or an activation number, but this is not necessarily so and the two numbers may not have a distinct meaning. First card number 151, as well as second card number 152 may have any number of digits, for example, sixteen digits, as in commonly used credit cards, in which case first card number 151 may appear to the merchant to be a regular card number, so that the merchant does not have to be aware of the existence of second card number 152. Other amount of digits, different from sixteen may be included in first card number 151 and second card number 152 and the number of digits in first card number 151 may be equal to or different from the number of digits of second card number 152.

Cardholder 180 purchases, while browsing, in a commercial website 190 and pays for the purchase by providing first card number 151 of dual number payment card 150. In return, website 190 provides cardholder 180 with an order number. However, the transaction is not approved until dual number payment card 150 is authenticated in validation system 100.

After the purchase, cardholder 180 contacts validation system 100 over, e.g., a telephone network, requesting an order approval. Cardholder 180 provides validation system 100 with the order details, including: (i) second card number 152 of dual number payment card 150; (ii) an identification of website 190, such as a URL, an IP-address or any other unique identification of website 190; and (iii) the order number that was provided during the purchasing. Optionally, the order details may include additional details, such as a payment amount.

Cardholder 180 can submit the order details to validation system 100 by sending an SMS message, by following instructions of an automatic voice answering machine of validation system 100, by calling a manned call center and any other telephone communication means.

Validation system 100 then contacts website 190, based on the identification of the website that was reported by cardholder 180. Validation system 100 contacts website 190 via a network, e.g., Internet 170, and requests order details that correspond to the order number reported by the user. Website 190 replies with the order details that include at least first card number 151 and, optionally, the payment amount.

At this stage, validation system 100 holds both first card number 151 and second card number 152 of dual number payment card 150 used in the specific electronic purchase, wherein first card number 151 was provided to validation system 100 by website 190 over one path, the Internet, and second card number 152 was provided to validation system 100 by cardholder 180 over another path, telephone network 160.

Validation system 100 checks whether both first card number 151 and second card number 152 belong to the same card. If both numbers match a pair of numbers that are pre-stored in a card details storage 131, then validation system 100 approves the transaction both to website 190 and to cardholder 180. If the numbers do not match any pre-stored pair of numbers, then a rejection of the transaction will be notified to both parties. The approval of the transaction may be further based on the payment amount, for example: whether the payment amount reported by the cardholder is the same as the payment amount reported by the website; whether the credit assigned to the cardholder allows a withdrawal of the payment amount; and/or whether a prepaid amount, which is associated with the dual number payment card (in this case a prepaid card) is sufficient to allow a withdrawal of the payment amount. Validation system 100 may perform additional procedures related to the transaction, such as debiting a bank account of the cardholder or subtracting the payment amount from the prepaid card.

Validation system 100 can communicate with multiple cardholders and multiple websites and includes two distinct network interfaces that allows a total separation of a reception of the two numbers of the card and enables the two reports, of the two numbers of the card, to be carried over two distinct networks.

A first network interface is for receiving order approval requests from the multiple cardholders and a second network interface is for communicating with websites and for obtaining purchase details from the websites. Typically, the first network interface is a telephone network interface 110, as illustrated in FIG. 1, while the second network interface is a web network interface 120 of FIG. 1. Although FIG. 1 illustrates the first network interface as a telephone network interface and the second network interface as a web network interface, any other network interface may be used as long as the two network interfaces are distinct interfaces and preferably utilize different infrastructure or different type of networking, so that the possibility of concurrent interception is eliminated. It should be noted, that for the sake of simplicity of explanation only, the following description refers to the first network interface as a telephone network interface, however, the first network interface may also be a packet based network interface or any other type of network interface, and the first network may be a packet based network or any other network suitable for transmission of information. In the same manner, the following description refers to the second network interface as a web network interface, however, the second network interface may also be any other type of network interface and the second network may be any other network suitable for transmission of information.

Validation system 100 further includes a card details storage 131 for storing details of multiple dual number payment cards, wherein the details include at least a pair of numbers for each card. The card details may include additional information, such as: cardholder's details, expiration date, amount limit for prepaid card and the like. Preferably, card details storage 131 is a secure card details storage. A new pair of numbers is issued and stored in card details storage 131 when a new dual number payment card is issued to a client. Each number of the pair of numbers is a unique number that does not exist in card details storage 131 before the issuance of the new card.

Validation system 100 further includes a central processor 140 for controlling telephone network interface 110 and web network interface 120; for receiving order details, through telephone network interface 110, from cardholders who request order approvals; for requesting partial card details from the websites; for determining a match, between: a pair of numbers stored in card details storage 131, and the first card number received from a cardholder, combined with the second card number received from a website; and for sending an approval or rejection of the transaction to the website and to the card holder. Central processor 140 may be further configured to produce new pairs of numbers for new dual number payment cards.

Referring back to card details storage 131. Since card details storage 131 stores highly confidential information, it is preferably enclosed inside a secure vault entity 130, such as a secure server, or may include any hardware and software required to protect card details storage 131 as well as a secure channel 135 that is the only communication line (though an internal one) that carries both numbers of the card. Secure vault entity 130 further includes a vault processor 132 that receives, from central processor 140, both first card number 151 and second card number 152, over secure channel 135. Vault processor 132 is configured to search card details storage 131 for a matching pair, upon receiving the two numbers from central processor 140 and to respond with a result of the search.

Telephone network interface 110 is configured to support telephony messaging of various messaging technologies, known in the art. Non limiting examples of supported telephony messaging technologies include: (i) an SMS (Short Message Service) messaging or any other type of electronic text messaging; (ii) voice messaging that is configured to parse DTMF (Dual Tone Multi Frequency) signals, (iii) voice messaging that is configured to record audio messages and to parse the recorded audio messages using voice recognition techniques; (iv) a FAX messaging; and (v) a manned call center with personnel that answers the phone calls and types the order details into the system, using a dedicated GUI.

According to the supported telephony messaging technologies, telephone network interface 110 includes at least one of the following devices, all known in the art:

i. Electronic text messages gateway, such as an SMS gateway, for receiving text messages, e.g., SMS messages, sent from the cardholders' phone. The electronic text messages gateway is further configured to interpret the received text messages, so as to extract order details from the messages;

ii. An Interactive automated Voice Response (IVR) system or device that can guide calling cardholders to enter details of the purchase order. The IVR system may be configured to receive DTMF signals from the cardholder, to guide the cardholder to enter the order details by using the telephone buttons and to parse the DTMF signals into a digital format of order details.

iii. Additionally or alternatively, the IVR system can be further configured to record audio messages, to guide the cardholder to record the audio messages that includes audible order details. In case of using audio recording, the IVR system includes a DSP that performs voice recognition and parses the recorded audio messages into a digital format of order details, by implementing a voice recognition algorithm;

iv. A FAX server for receiving FAX messages. The FAX server may be a traditional telephony based FAX server, but may also be an internet FAX machine or a FAX over packet (e.g. FAX over IP) server. In the latter two cases, the first network interface is a packet network interface rather than a telephone network interface; and

v. Attended manned stations, such as in a call center, in which case, an employee in the manned station will question the cardholders for the order details and will manually type the order details into validation system 100.

After parsing the received order approval request (which is either an SMS message, DTMF signals, recorded audio or typed information), telephone network interface 110 handles the parsed order details to central processor 140.

Dual number payment card 150 may be a physical plastic card, but is preferably a virtual card that consists only of its details (the two numbers, expiration date, amount limitation, etc.) stored in card details storage 131. The issuance of dual number payment card 150 can be executed through an ATM machine, by a bank teller or by a bank call center. Upon issuance, the cardholder is provided with first card number 151 and second card number 152, which may be printed on two separate slips.

According to an embodiment of the invention, dual number payment card 150 is a temporary card, which restriction terms thereof are defined by the cardholder. The cardholder can choose to limit the terms of dual number payment card 150 by defining at least one of the following restrictions terms: (i) a limited payment amount—in this case, the card will be invalidated once the limited payment amount is consumed; (ii) number of transactions limitation—the cardholder may choose to limit the card to one transaction only or to any other number of transactions, defined by the cardholder; (iii) time limitation defined by the user (which is shorter or equal to a longest time limitation allowed by the card issuer). The card validity will be expired when any one of the restrictions terms, requested by the cardholder, is fulfilled.

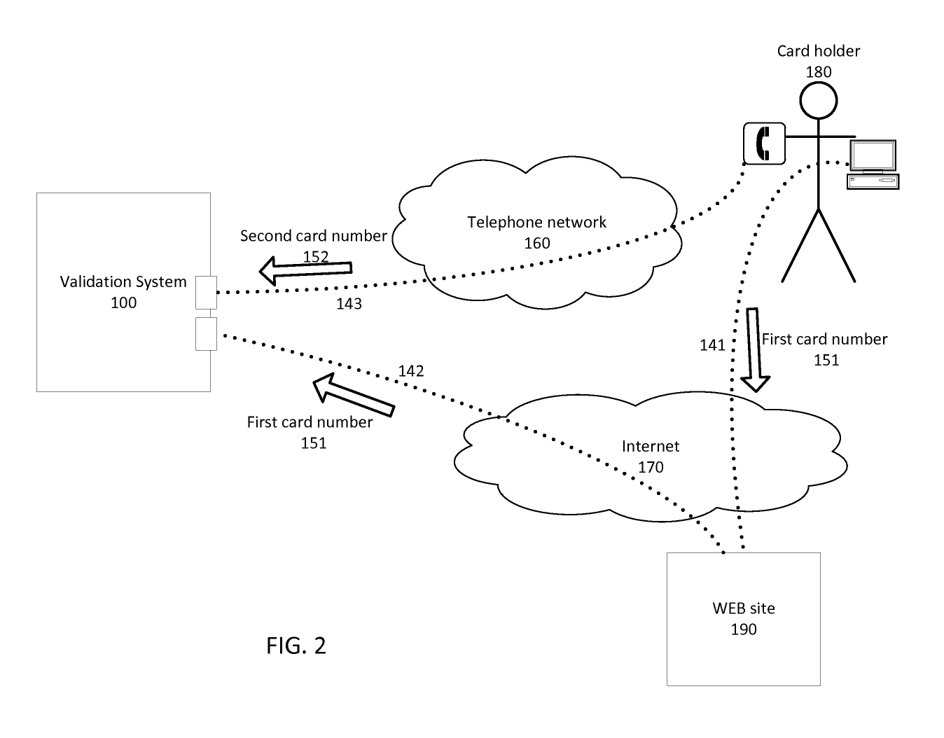

The principle of eliminating interception of the full card details circulated on the Internet is achieved by splitting the card number into two parts, wherein each part travels through a different network path and the same path never carries both parts of the number. This principal is further demonstrated in FIG. 2.

FIG. 2 illustrates a concept of branching the transmission of the split details of the card. The branching forms a virtual triangle with cardholder 180, website 190 and validation system 100—as its three vertices. The three sides of the triangle are composed of three paths illustrated by dashed lines: path 141—from cardholder 180 to website 190, path 142—from website 190 to validation system 100 and path 143—from cardholder 180 to validation system 100.

First card number 151 and second card number 152 traverse the network using two different routes: second card number 152 is transmitted from cardholder 180 to validation system 100 through a first route that is composed of path 143, utilizing the telephone network (also referred to as a first network) as a carrier medium, while first card number 151 is indirectly transmitted from cardholder 180 to validation system 100 using a second route composed of paths 141 and 142, utilizing the Internet (also referred to as a second network) as a carrier medium. It should be noted that no path, at any time, carries more than one number of the same card, so that a hacker monitoring a certain path is unable to obtain both numbers of the card. The two numbers are received by validation system 100 through two different entry points: telephone network interface 110 and web network interface 120, so that monitoring an entry point of validation system 100 would not allow obtaining both numbers of the card. Furthermore, since the merchant is provided with only one number of dual number payment card 150, he is prevented from maliciously (or carelessly) using the card for purposes other than the specific order.

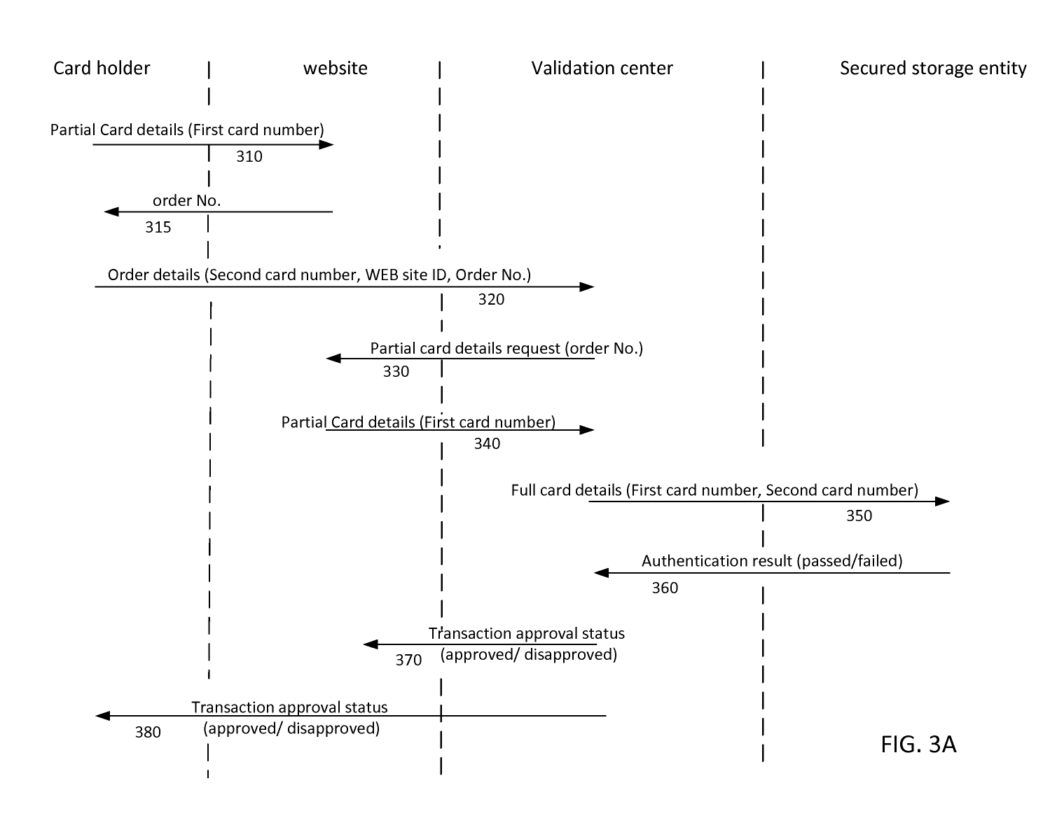

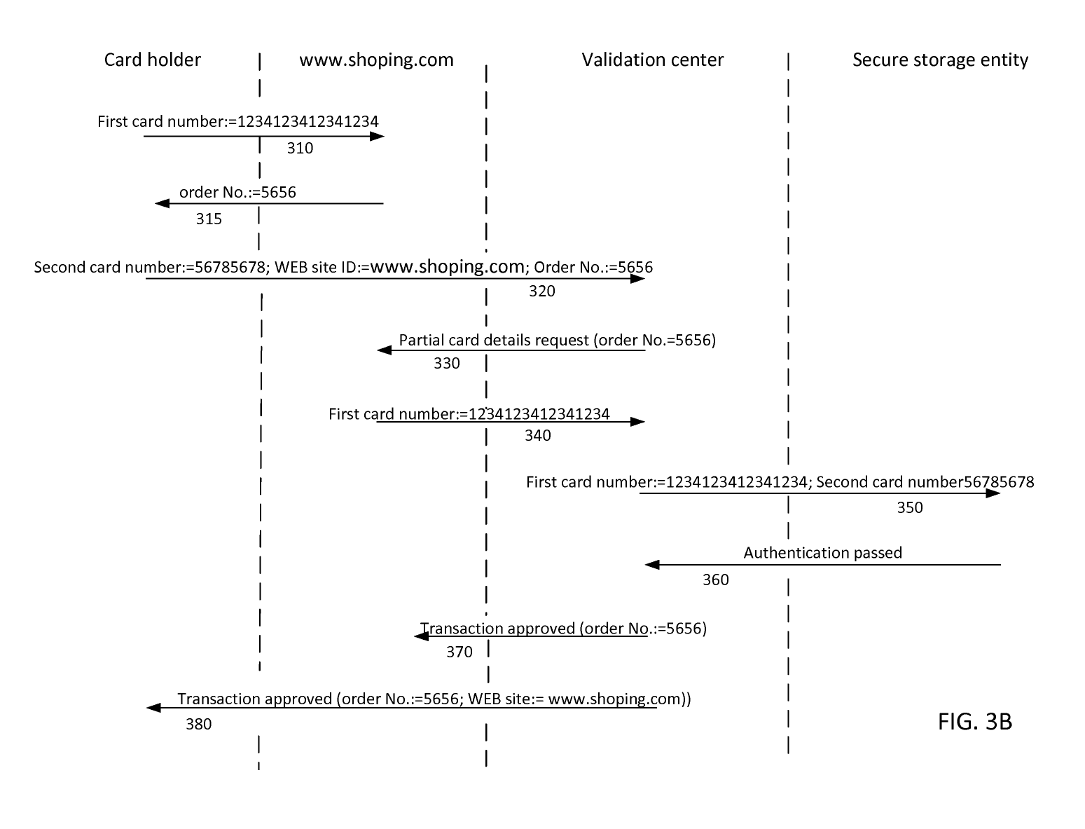

FIG. 3A is a sequence diagram that illustrates a flow of messages included in a purchase transaction that utilizes dual number payment card 150. The messages flow among several entities: (i) the cardholder , or more precisely, a communication apparatus used by the cardholder, such as a telephone, a computer with a web browser, and the like; (ii) a commercial website; (iii) a validation center where validation system 100 resides and, more specifically, central processor 140 of validation system 100; and (iv) a secure storage entity such as secure vault entity 130, that may be part of validation system 100 or coupled to validation system 100.

The sequence starts when the cardholder browses the commercial website, selects items he wishes to purchase and chooses to pay with a dual number payment card. The cardholder sends partial card details 310 to the website, wherein partial card details 310 include only a first card number of the card. The first card number may appear to the website operator to be a full card number, as it may include sixteen figures, as in a regular credit card. The website replies with an order number 315, which later identifies the order at the verification center. Messages 310 and 315 that are communicated between the cardholder and the website are transmitted over a second network, which is typically the Internet.

After the purchase is completed, the payment is not yet approved until after the cardholder contacts the verification center. The cardholder then sends order details 320 to the validation center, wherein order details 320 include: a second card number, the order number that was provided by the website and the website identification, such as a URL or an IP-address. Message 320 is transmitted over a first network that is different from the second network, such as, for example, the telephone network.

In case of using a telephone network for the order verification, the cardholder may transmit order details 320 by using an SMS message or any other electronic text message, call a voice messaging system that records a voice message, call a voice messaging system that instructs the user to enter DTMF codes or call a manned call center.

After acquiring the order details from the cardholder, the verification center sends a partial card details request 330 to the website, which was identified in message 320. Partial card details request 330 includes at least the order number that was specified in message 320. Optionally, the validation center may send an order details request instead of just requesting the partial card details, in which case the validation center would expect to receive further details regarding the order, such as a payment amount. The website then responds with partial card details 340 that include the first card number that was used for paying the order associated with the order number. Optionally, in the case that the verification center requests further order details, the response may include the payment amount or any other requested details related to the order. Typically, messages 330 and 340 are transmitted over the Internet (the second network).

The verification center may employ a separate secure storage entity coupled to the central processor through a secure communication channel. In case a separate secure storage entity is employed, the verification center sends an encrypted message over the secure communication channel—full card details 350 that include both the first card number and the second card number. After checking a secure storage that stores multiple pairs of card numbers, the secure storage entity responds with an authentication result 360, which includes an indication: authentication passed or authentication failed.

The validation center sends a transaction approval status 370 and 380, which is based on authentication result 360, to both the website and the cardholder, respectively. If the authentication result indicates that the authentication succeeded, then transaction approval status 370, 380 indicates that the transaction is approved. Transaction approval status 370, 380 indicates that the transaction is rejected (or disapproved) if the authentication result indicates that the authentication failed. Transaction approval status 370, that is sent to the website, further includes the order number. Transaction approval status 380 that is sent to the cardholder further includes the order number and the website identifier.

FIG. 3B illustrates the same sequence diagram as FIG. 3A but with specific parameters. The cardholder sends message 310 to site www.shoping.com with his first card number: 1234123412341234. The site confirms reception of the first card number by sending message 315 with an order number set to 5656. The cardholder sends message 320 to the validation center with the order details: Second card number=56785678; website ID=www.shoping.com; Order No.=5656. The validation center sends message 330 with order number=5656 to www.shoping.com, which replies with message 340 that includes first card number=1234123412341234. The validation center sends the secure storage entity message 350 that includes: first card number=1234123412341234 and second card number=56785678. The storage is searched for a card with a matching pair of numbers, which is found, in this case. The secure storage entity replies with message 360, indicating that the authentication passed. The validation center sends a transaction approval 370 to www.shoping.com with order-number=5656. The validation center also sends a slightly different transaction approval 380 to the cardholder that includes: website address=www.shoping.com in addition to order-number=5656.

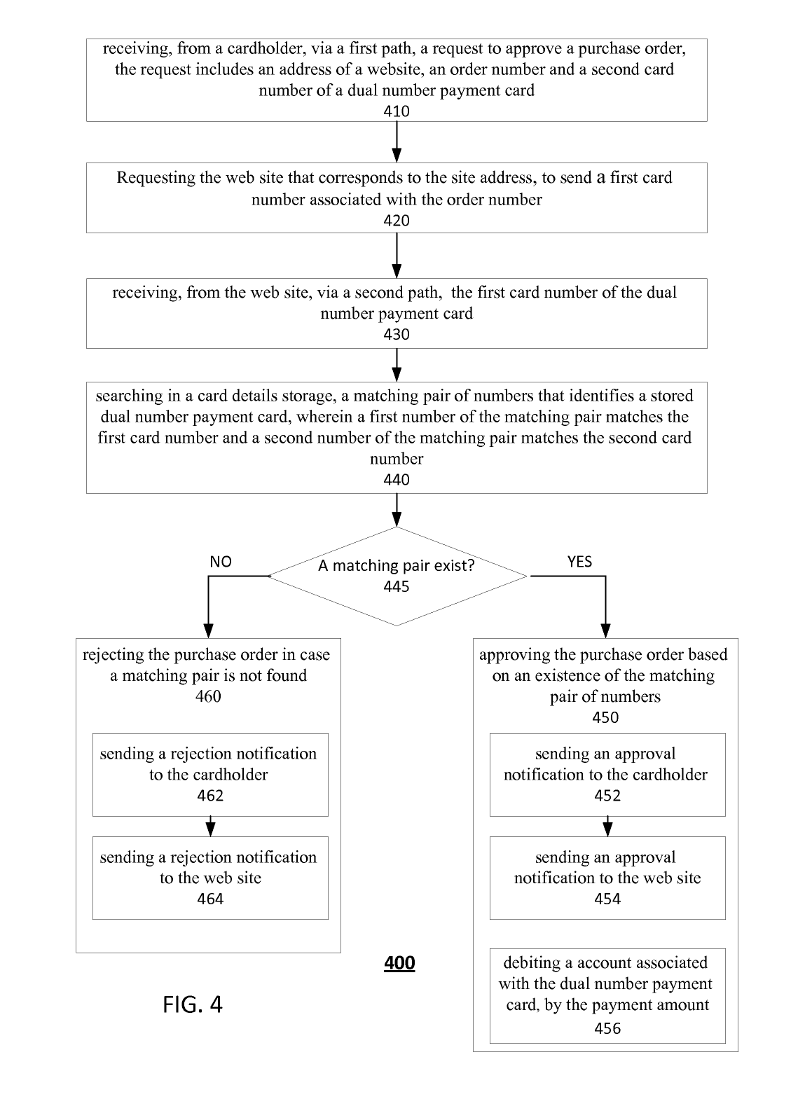

FIG. 4 illustrates a flowchart of a method 400 for securely authenticating a dual number payment card and approving a purchase order in which a dual number payment card was used for the payment of the order. Method 400 is triggered when a cardholder chooses to pay for goods or services offered by a website, by using the dual number payment card. Method 400 may be implemented by a system that resides in a validation center, such as validation system 100.

Method 400 begins with a stage 410 of receiving, from a cardholder, via a first path, a request to approve a purchase order, wherein the request includes a site address of a website, an order number and a second card number of a dual number payment card. The website is any commercial website that offers goods and/or services and allows cardholders to order and pay through this website. The address of the website may be a

URL, an IP address or any other notation used to identify a specific website. The request to approve a purchase order may additionally include a payment amount of the purchase.

The order number, that identifies the purchase order within the website, was provided to the cardholder by the website, during a purchase transaction, in response to a first card number that the cardholder sent to the website during the transaction, via a second network.

According to another embodiment of the invention, the user is not required to send the first card number, as the website may already be familiar with the first card number. The owner of the website may allow frequent buyers to register to the website and fill-in their details, including the first card number. Since the first card number is not vulnerable to malicious usage, as it is worthless without the second card number, the owner of the website can legitimately store the details of the buyers, including the first card number, in a buyers' storage. The buyer, i.e. the cardholder of the dual number payment card, can sign into the site with a user name and password that was established during the registration, and then place orders, without a need to provide the first card number that is already known to the website. The order number, in this case is provided to the user when the user confirms the purchase.

Stage 410 is followed by a stage 420 of requesting the website that corresponds to the site address, to send a first card number associated with the order number.

Stage 420 is followed by a stage 430 of receiving, from the website, via the second path, the first card number of the dual number payment card. The website may further report the payment amount of the purchase.

The first path includes the first network and the first network interface of the validation system, that is coupled to the first network. The first network is any communication media and may be, for example, a telephone network. The second path includes the second network and the second network interface of the validation system, that is coupled to the second network. The second network is any communication media and may be, for example, the Internet. However, any other network type may be used as a carrier, as long as the two networks are distinct networks that preferably utilize different infrastructure or different type of networking, so that the possibility of concurrent interception is eliminated.

Stage 420 of requesting the website to send the first card number, is an optional stage, in which case the website unsolicitedly sends the first card number in addition to the order number, in response to an order that was placed on the website by the cardholder. If the website, rather than the validation center, initiates the transmission, then the reports of both numbers of the card (i.e., the first card number that is reported by the website at stage 430 and the second number that is reported by the cardholder at stage 410) arrive in the validation system asynchronically, i.e. stages 410 and 430 are simultaneous stages and thus either of the two reports may precede the other. In this case, the validation system has to manage a cache storage that holds the details of the first report to arrive until a second report, with the same order number and website address arrives. After both reports are received, they can be removed from the cache storage and the approval stage can take place. As an example: assuming the first report arrives from the website and includes at least: website-identifier=www.buyhere.com; order number=12345; first card number=1234567890123456. The validation system searches the cache storage for a matching website ID and order number and since this parameter combination is not found (no report for this combination has yet arrived), the validation center places the first report details in the cache storage. Then the second report arrives from the user and includes at least: website-identifier=www.buyhere.com; order number=12345; second card number=9876543210987654. The validation system searches the cache storage for a matching website ID and order number, which are found, this time. The validation center removes the first report from the cache and proceeds to the approval stage.

Stage 430 is followed by a stage 440 of searching in a card details storage, for a matching pair of numbers that identifies a stored dual number payment card, wherein a first number of the matching pair is equal to the first card number and a second number of the matching pair is equal to the second card number.

Stage 440 may include sending a search request to a secure vault entity and receiving from the secure vault entity an existence indication. The secure vault entity includes the card details storage and is coupled to a central processor of the validation system through a secure communication line to protect the full details of the card. The secure vault entity includes a secure processor that controls the search and response with the existence indication that indicates whether a matching pair exists.

Stage 440 is followed by a question 445 that indicates a branching derived as the result of the question: Does a matching pair exist? If the answer is “yes”—then question 445 is followed by a stage 450, and if the answer is “no”—then question 445 is followed by a stage 460.

Stage 450 includes approving the purchase order based on an existence of the matching pair of numbers.

Optionally, the stage of approving the purchase order may further be based on the payment amount and a balance of a financial account associated with the dual number payment card. For example: whether the credit assigned to the cardholder's bank account allows a withdrawal of the payment amount; whether a prepaid amount, which is associated with the dual number payment card (in this case it is a prepaid card) is sufficient to allow a withdrawal of the payment amount. In addition the approval may include checking whether the payment amount reported by the cardholder is the same as the payment amount reported by the website.

Stage 450 may include a stage 452 of sending an approval notification to the cardholder and a stage 454 of sending an approval notification to the website. The approval notification includes an indication that the transaction is approved and the order number. The approval notification that is sent to the cardholder further includes the site address of the website. Stage 450 may further include a stage 456 of debiting a financial account associated with the dual number payment card, by the payment amount that was reported by the cardholder. The debiting may be of a bank account or subtracting the payment amount from a prepaid card.

Stage 460 includes rejecting the purchase in case a matching pair is not found. The rejecting may include a stage 462 of sending a rejection notification to the cardholder and a stage 464 of sending a rejection notification to the website. The rejection notification includes an indication that the transaction is rejected and the order number. The rejection notification that is sent to the cardholder further includes the site address of the website. The stage of sending the rejection is optional, since the website may be able to reject the order based on an elapsed timer.

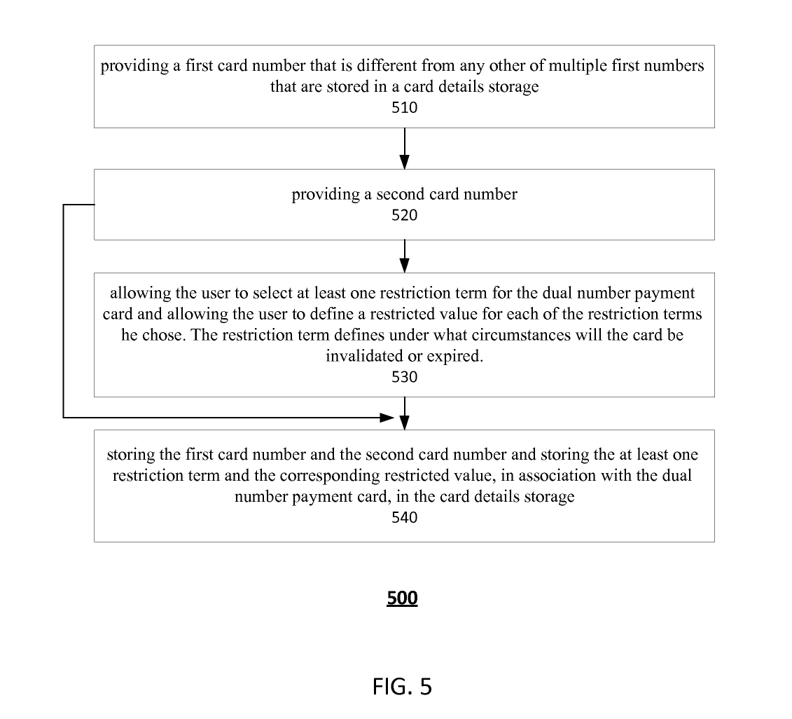

FIG. 5 illustrates a flowchart of a method 500 for providing a dual number payment card to a user. The user may request an issuance of the dual number payment card by using an ATM machine, by calling a bank call center or may ask a bank teller for the issuance. The method may be implemented by validation system 100. As a result of the issuance request, the user may receive two slips, each containing one number of the dual number payment card. The term ‘card’, in this case, referrers to a virtual card. The dual number payment card may be a credit card, a debit card, a prepaid card and the like. The method begins with a stage 510 of providing a first card number that is different from any other of multiple first numbers that are stored in a card details storage. The card details storage stores the details of all the dual number payment cards that were issued to users.

Stage 510 is followed by a stage 520 of providing a second card number. The first card number is intended for transmission, via a first path, from the user to a merchant, e.g. a website, during a payment stage of a transaction. The second card number is intended for transmission, via a second path, from the user to the validation center, for requesting a purchase approval.

Stage 520 if followed by an optional stage 530 or by a stage 540. Stage 530 includes allowing the user to select at least one restriction term for the dual number payment card. The restriction term defines under what circumstances will the card be invalidated or expired. Non limiting examples of restriction terms include: (i) a restricted number of transactions; (ii) a restricted payment amount; and (iii) a restricted expiration date.

Stage 530 further includes allowing the user to define a restricted value for each of the restriction terms he chose. If the user chooses to restrict the number of transactions, then he is requested to define the maximum number of transactions that the dual number payment card will be valid for. If the user chooses, for example, the maximum number of transactions to be two, then after two transactions, the card will be invalidated. i.e. trying to approve a third transaction will result a rejection of the transaction. If the user chooses to restrict the payment amount, then he is requested to define the total payment amount that can be paid using the dual number payment card. If the user chooses, for example, a payment amount of one thousand dollars, the first transaction that will exceed a total of one thousand dollars (all together for all purchases) will result a rejection of the transaction when the user will request an approval. If the user chooses to restrict the expiration date, then he is requested to define the new expiration date. The default for the expiration date is defined by the card issuer and can be shortened by the user, but cannot be extended. If the user tries to approve a transaction that executed on a date that is beyond the defined expiration date, the transaction will be rejected.

Stage 530 is followed by a stage 540 of storing the first card number and the second card number, in association with the dual number payment card, in the card details storage. If stage 530 was performed, then stage 540 further includes storing the at least one restriction term and the corresponding restricted value, in association with the dual number payment card, in the card details storage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for securely authenticating a dual number payment card and for approving a purchase order, the method comprising the steps of:
receiving, from a cardholder, via a first path, a request to approve a purchase order, wherein the request includes a site address of a website, an order number and a second card number of a dual number payment card;
receiving, from the website, via a second path, a first card number of the dual number payment card, associated with the order number;
searching in a card details storage, for a matching pair of numbers that identifies a stored dual number payment card, wherein a first number of the matching pair matches the first card number and a second number of the matching pair matches the second card number; and
approving the purchase order based on an existence of the matching pair of numbers.

2. The method of claim 1, wherein the first card number is a number provided by the cardholder to the website, via the second path, during a purchasing

3. The method of claim 2, wherein the order number is a number provided by the website to the cardholder, in response to the provision of the first card number.

4. The method of claim 1, wherein the receiving of the first card number is preceded by a step of requesting the website that corresponds to the site address, to send the first card number that is associated with the order number.

5. The method of claim 1, wherein the approving of the purchase order comprises sending an approval notification to the cardholder and to the website.

6. The method of claim 1 further comprising rejecting the purchase order in case the step of searching fails to find the matching pair of numbers.

7. The method of claim 1, wherein the step of searching further comprises sending a search request to a secure vault entity that includes the card details storage; and receiving from the secure vault entity an existence indication, wherein the step of approving is based on the existence indication.

8. The method of claim 1, wherein the first path includes a telephone network.

9. The method of claim 1, wherein the second path includes an internet.

10. The method of claim 1, wherein the approving of the purchase order is further based on at least one factor selected from of a list consisting of: (i) a payment amount, that is included in the request to approve the purchase and a balance of a financial account associated with the dual number payment card; (ii) a pre-defined expiration date; and (iii) pre-defined maximum number of transactions.

11. A validation system for secure authentication of a dual number payment card and for a purchase order approval, comprising:
a first network interface, for receiving, from a cardholder, via a first path, a request to approve a purchase order, wherein the request includes a site address of a website, an order number and a second card number of a dual number payment card;
a second network interface, for receiving, from the website, via a second path, a first card number of the dual number payment card, associated with the order number;
a card details storage for storing multiple pairs of numbers, corresponding to multiple dual number payment cards;
a central processor, coupled to the first network interface, to the second network interface and to the card details storage, wherein the central processor is configured to utilize the card details storage, for determining an existence of a matching pair of numbers, that identifies a stored dual number payment card, wherein a first number of the matching pair matches the first card number and a second number of the matching pair matches the second card number.

12. The validation system of claim 11, wherein the central processor is further configured to approve the purchase order based on the existence of the matching pair of numbers.

13. The validation system of claim 11, wherein the second network interface is configured to transmit to the website, that corresponds to the site address, a request to send the first card number associated with the order number.

14. The validation system of claim 11, wherein the second network interface is configured to transmit to the website, that corresponds to the site address, an approval notification that approves the purchase order.

15. The validation system of claim 11, further comprising a secure vault entity that comprises:
the card details storage; and
a vault processor for receiving the first card number and the second card number from the central processor through a secure channel, for searching the card details storage for the matching pair of numbers, and for sending an existence indication, that indicates the existence of the matching pair, to the central processor.

16. The method of claim 11, wherein the first network interface is a telephone network interface.

17. The method of claim 11, wherein the second network interface is a web network interface.

18. The system of claim 11, wherein the first network interface comprises at least one device selected from a list consisting of: (i) electronic text messages gateway, for receiving text messages from cardholders and for interpreting received text messages, so as to extract order details that include: the second card number, the order number and the site address; (ii) a first voice response device for receiving dual tone multi frequency (DTMF) signals and for parsing the DTMF signals into a digital format of the order details; (iii) a second voice response device for recording audio messages and for parsing the recorded audio messages into a digital format of the order details; and (iv) a facsimile server.

19. A method for providing a dual number payment card to a user, the method comprising the steps of:
providing a first card number that is different from any other of multiple first numbers that are stored in a card details storage;
providing a second card number; and
storing the first card number and the second card number, in association with the dual number payment card, in the card details storage;
wherein the first card number is intended for transmission, via a first path, from the user to a merchant, during a payment stage of a transaction; and the second card number is intended for transmission, via a second path, from the user to a validation center, for requesting a purchase approval.

20. A method of claim 19 further comprising:
allowing the user to select at least one restriction term for the dual number payment card, the restriction term is selected from a group consisting of: a restricted number of transactions, a restricted payment amount and a restricted expiration date;
allowing the user to define at least one restricted value, respectively associated with the at least one selected restriction term; and
storing the at least one restriction term and the at least one restricted value, in association with the dual number payment card, in the card details storage.
